(19) United States
(12) Patent Application Publication
(10) Pub. No.: US 2016/0296978 A1
(43) Pub. Date: Oct. 13, 2016

(54) A Cleaning Device

(71) Applicant: Stephen Okusaga, London (GB)

(72) Inventor: Stephen Okusaga, London (GB)

(21) Appl. No.: 15/101,058

(22) PCT Filed: Dec. 4, 2014
(86) PCT No.: PCT/GB2014/000501

§ 371 Date: Jun. 2, 2016

(30) Foreign Application Priority Data
Dec. 4, 2013 (GB) 1321411.9

(51) Int. Cl. B08B 1/00; A47L 13/04; A47L 17/08; A47L 13/16

(52) U.S. Cl. CPC B08B 1/006; A47L 13/16; A47L 13/04; A47L 17/08

(57) ABSTRACT

A cleaning device for the manual cleaning of dust, dirt and grease from surfaces including walls, worktops, basins, and cooking implements in a domestic or commercial setting. In one embodiment, a cleaning device is provided to be more easily retained by the user. A first aspect of the invention provides a cleaning device comprising a cleaning material and an aperture through which, in use, the fingers of a user's hand can pass such that the cleaning device surrounds a part of the user's hand. The device can be retained on a user's hand in such a way that both sides of the hand may be used for cleaning.

### FIELD OF THE INVENTION

The present invention relates to a cleaning device apparatus for the manual cleaning surfaces. More particularly, the present invention relates to the removal of dust, dirt and grease in the cleaning of surfaces including walls, worktops, basins, and cooking implements in a domestic or commercial setting or, without loss of generality, the manual cleaning of kitchen work surfaces, crockery, pans and cutlery.

### BACKGROUND OF THE INVENTION

Many cleaning tasks, such as the cleaning of heavy pans, require the use of more than one surface to successfully dislodge dirt and grease. The need to switch between different products in the performance of a single cleaning task can be arduous and time consuming.

For users with low dexterity and those requiring the simultaneous use of aids, such as crutches, whilst performing cleaning tasks, providing the grip necessary to retain the cleaning device within the hand is often problematic.

Users with medical conditions, such as arthritis, may be unable to open and close the hand to a degree necessary to grip and release cleaning device. Further, retaining the device within the hand while applying the requisite pressure and motion required to clean a target surface is frequently impossible.

In the cleaning of heavily soiled surfaces, there is often a need to continuously swap between a scouring pad and an iron/wire scourer, which is also frequently difficult when suffering from low dexterity in hands.

There is therefore a need for cleaning devices easily retained within the hand when in use.

A known cleaning device is disclosed in U.S. Pat. No. 5,569,521, which proposes a cleaning pad of rectangular cross-sectional area with a strap passing across the back of the user's hand to retain the pad against the palm.

The device has a single cleaning surface parallel to the user's palm. The device also requires the user to maintain the hand in a single position.

### SUMMARY OF THE INVENTION

It is an object of the present to provide a cleaning device more easily retained by the user. A first aspect of the invention provides a cleaning device comprising a cleaning material and an aperture through which, in use, the fingers of a user's hand can pass such that the cleaning device surrounds a part of the user's hand. The device can be retained on a user's hand in such a way that both sides of the hand may be used for cleaning.

Preferably, the device covers only a part of the user's hand, for example less than 50% or even less than 25% of the hand.

The device may comprise a closed loop of a cleaning material and preferably comprises two different cleaning materials, for example one or more of sponge, a washing pad, scouring pad, a duster, iron wire mesh, nylon mesh, and a microfibre cloth may be used.

A first of said two materials may be abrasive to allow scrubbing, possibly using the back of the hand or the knuckles. A second of said two materials may be non-abrasive to allow for more delicate cleaning.

The second material is, in use, preferably located against the palm of a user's hand. The first material is, in use, preferably located against the back of a user's hand.

By allowing the user to wear the device, the user is afforded an increased level of flexibility. Both cleaning surfaces may be used at the same time by simply rotating the device in a clockwise or anticlockwise movement around an area of the hand, thus allowing for abrasive and non-abrasive application in cleaning.

The device can also be moved up and down the knuckles, palm or digits of the user's hand by simply sliding the device around the hand when needed. The cleaning of objects with a circular or 90 degree angle is therefore made easier and more precise.

The first material may form a closed loop providing the aperture for a user's hand, and the second material may surround a part of, and be movable relative to, the closed loop of the first material. This allows a fresh part of the first material to be exposed as required. To facilitate the sliding action, a small gap, for example of 1 mm or 2 mm, is preferably provided between the first and second materials.

The cleaning device may be manufactured by forming a ring of a first material; wrapping a second material around a part of the ring of the first material; and preferably bonding the second material to form a tube around the first material.

The invention provides a highly versatile device for scouring, dish washing, rinsing, scrubbing and dusting. By forming the device entirely of usable cleaning material, cleaning may be performed using all parts of the device.

The device can comprise a scourer/sponge wrapped and bound around a substrate comprised of metal wool. The latter covers the knuckle for scouring and the former the palm. Each of the materials may be abrasive or non-abrasive in form.

### BRIEF DESCRIPTION OF THE DRAWINGS

Preferred embodiments of the present invention will now be described, by way of example only, with reference to the accompanying drawings, in which:

FIG. 1 is a representation of the cleaning device comprising two cleaning substrates, a steel wool mesh and a nylon mesh;

FIG. 2 is a representation of the cleaning device of FIG. 1, in which the rectangular washing pad is wrapped around the steel wool mesh to form a circular enclosure with a 1 mm gap between the substrates;

FIG. 3 shows a cross section of the cleaning device of FIGS. 1 and 2 showing the 1 mm gap between the two substrates;

FIGS. 4 and 5 show the cleaning device in a first mode of use;

FIGS. 6 and 7 show the cleaning device used in a flat palm washing and scouring orientation;

FIGS. 8a and 8b show the cleaning device in use in a front of hand orientation;

FIGS. 9a and 9b show the cleaning device in use in a back of hand orientation;

FIG. 10 shows the cleaning device in an alternate mode of use;

FIG. 11 shows an embodiment of the cleaning device comprising an abrasive surface; and

FIG. 12 shows an embodiment of the cleaning device comprising a non-abrasive surface.

### DETAILED DESCRIPTION OF THE EMBODIMENTS

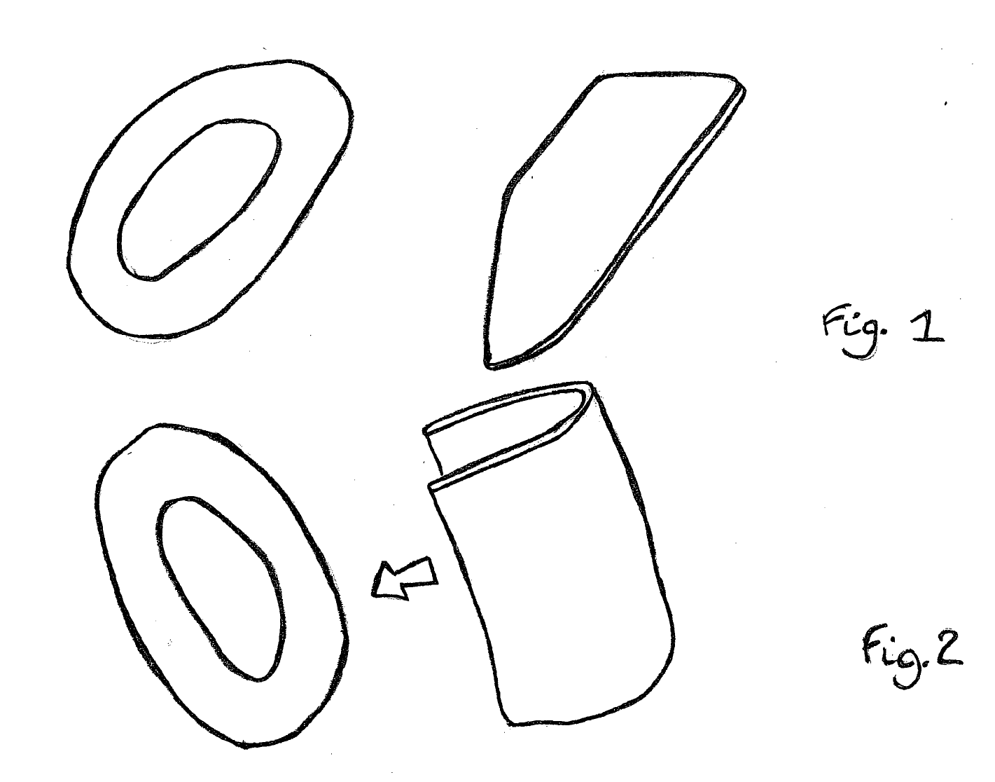

A first embodiment of the invention is shown in FIG. 1, in which the cleaning device is comprised of two cleaning materials. A first cleaning material is formed into a ring-like substrate that provides a first cleaning surface. A second material that partially encloses the substrate provides a second cleaning surface.

FIG. 2 is a schematic representation of the cleaning device of FIG. 1, in which the rectangular washing pad is wrapped around the steel wool mesh to form a circular enclosure with a 1 mm gap between the substrates.

According to this particular embodiment, an abrasive substrate comprised of a steel wool is partially surrounded by a second material.

The second material is based on a mixture of fibers of polyester and polyamide, the latter having similar physical properties to those of polyurethane foam.

The second material is placed around the substrate of first material of steel wool, and joined by heat sealing, either directly or by means of two layers of a heat fusible material or thermoramollissant arranged on either side of said washing pad.

The selection of materials used in the heat sealing composition according to the embodiment gives the advantage of improved cleaning properties, as well as the ability to manufacture the device using thermo-welding.

The heat seal formed is strong, non-brittle and non-cutting, and therefore does not affect the quality of the second material.

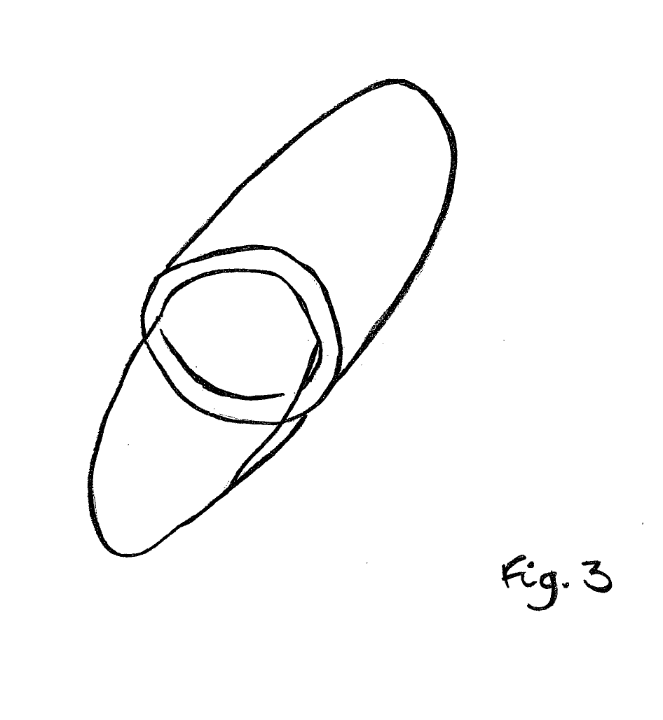

FIG. 3 shows a cross section of the cleaning device with 1 mm gap between the two materials. After heat sealing, a gap of approximately 1 mm is formed between the first and second material. This gap dimensionally stabilizes the steel wool in the region of the second material, and provides a clearance between the two materials to allow the first material to be pulled through the second material when an area of cleaning material degrades through use, or the user prefers the device in a different orientation. This allows for a longer lasting cleaning device.

FIG. 4 shows the cleaning device in use in a first orientation. The 1 mm gap between the materials allows the doughnut ring steel wool to be pulled through when an area wears down thus allowing a new part of the doughnut shaped steel wool to be used.

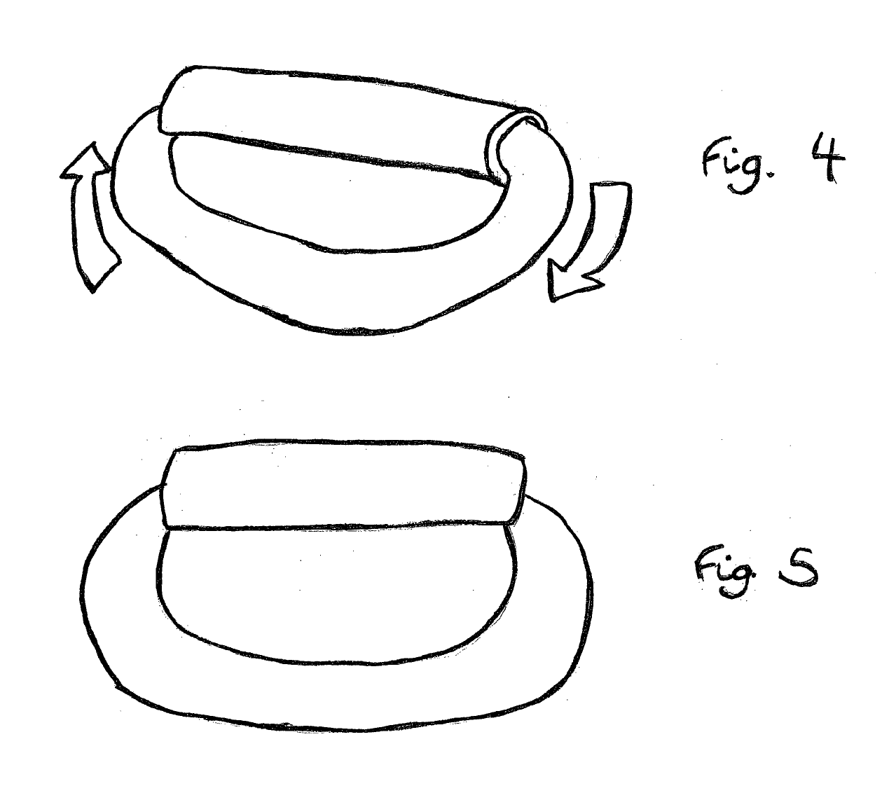

FIG. 5 shows the cleaning device in use. The elasticised ring-shaped steel wool allows the user to insert a hand through the grip in use.

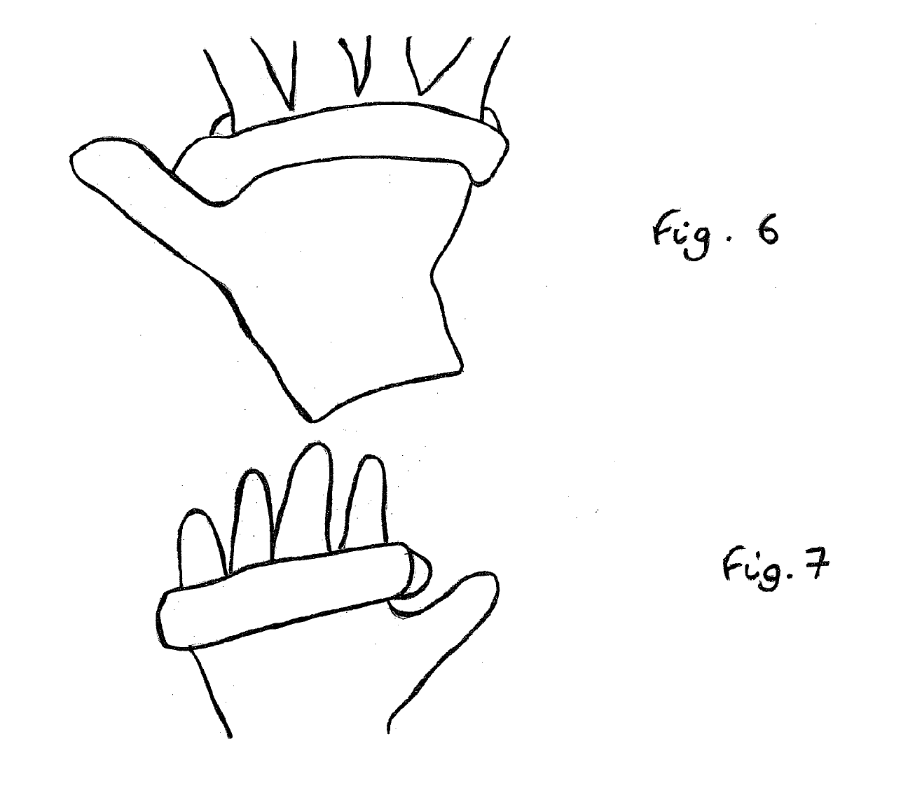

FIG. 6 shows a method of use for those with partial dexterity, or for users wearing gloves, in a flat palm washing and scouring orientation.

FIG. 7 further indicates the method of use described in FIG. 6, in a back of hand/knuckle scouring orientation.

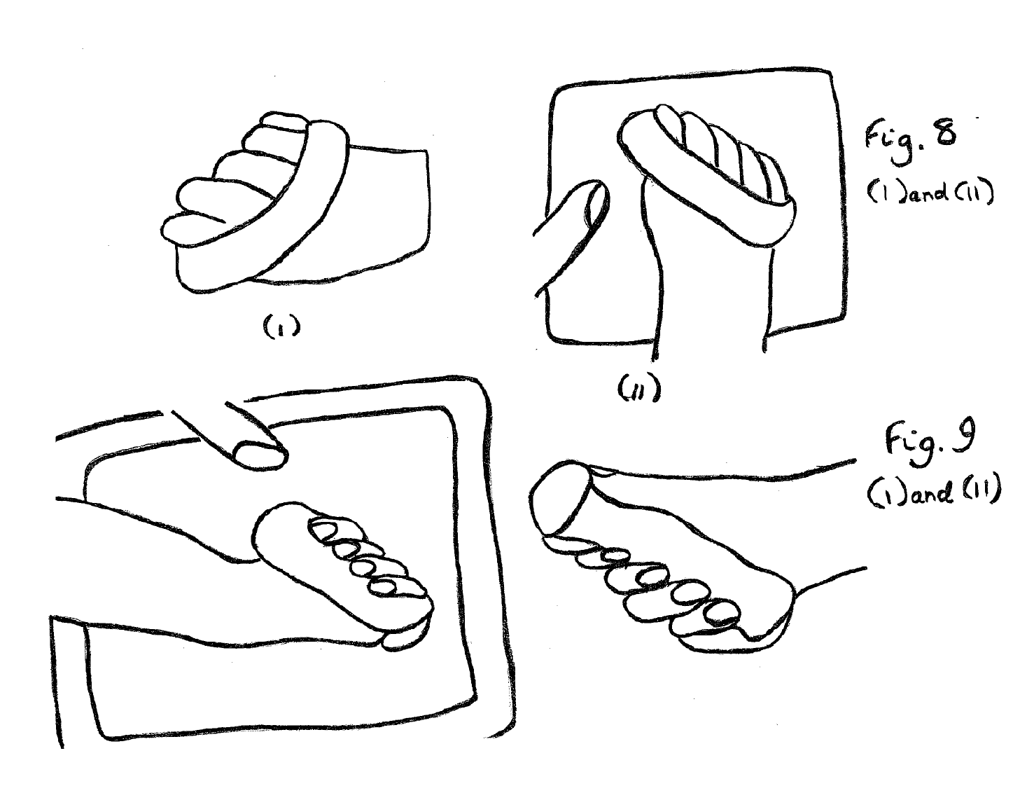

FIGS. 8a to 9b indicates a method of use by able bodied person, in which the device is used in an orientation in which the cleaning surface may be adjacent the palm or the knuckles. In the latter orientation, the user may employ knuckle pressure for a more powerful scour, an action requiring less physical strength as compared to employing a conventional scourer pressed against the palm or finger tips.

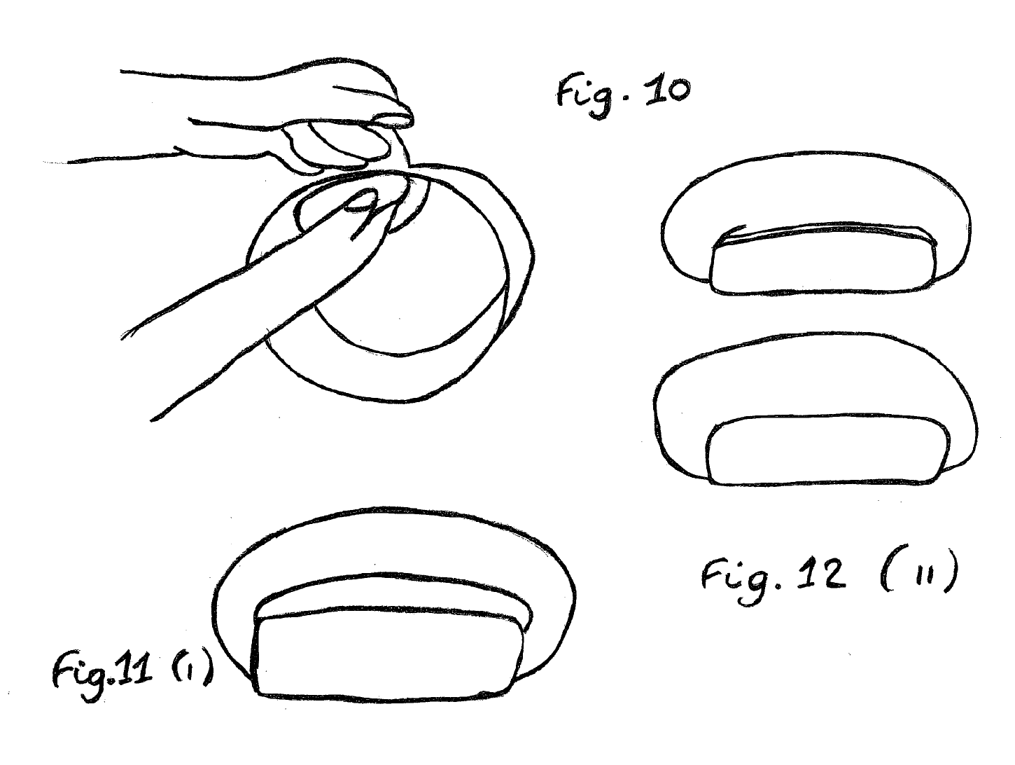

FIG. 10 demonstrates the flexibility of the scourer to allow a user to clean effectively in hard to reach corners of, for example cooking implements, as compared to conventional scouring pads.

FIGS. 11 and 12 show further illustrations of the cleaning device.

The device may be an assembly of various cleaning materials, including but not limited to materials suitable for sponging, scouring, and dusting. Such materials may include iron wire mesh, nylon mesh, and microfiber cloth formed and bonded to provide a secure, durable and flexible cleaner. Both the first and second materials may be abrasive or non-abrasive.

Although the invention has been described above with reference to one or more preferred embodiments, it will be appreciated that various changes or modifications may be made without departing from the scope of the invention as defined in the appended claims.

1. A cleaning device comprising a cleaning material and an aperture through which, in use, the fingers of a user's hand can pass such that the cleaning device surrounds a part of the user's hand.

2. A cleaning device according to claim 1, wherein the device covers only a part of the user's hand.

3. A cleaning device according to claim 1, wherein the device comprises a closed loop of a cleaning material.

4. A cleaning device according to claim 1, comprising two different cleaning materials.

5. A cleaning device according to claim 4, wherein the cleaning materials comprise one or more of sponge, a scouring pad, a duster, iron wire mesh, nylon mesh, and a microfibre cloth.

6. A cleaning device according to claim 4, wherein a first of said two materials is abrasive.

7. A cleaning device according to claim 4, wherein a second of said two materials is non-abrasive.

8. A cleaning device according to claim 7, wherein said second material is, in use, located against the palm of a user's hand.

9. A cleaning device according to claim 4, wherein said first material is, in use, located against the back of a user's hand.

10. A cleaning device according to claim 4, wherein said first material forms a closed loop providing said aperture and wherein said second material surrounds a part of, and is movable relative to, said closed loop of said first material.

11. A cleaning device according to claim 10, wherein a gap is provided between said second material and said first material.

12. A method of manufacturing a cleaning device according to claim 4, the method comprising steps of:
forming a ring of a first material; and wrapping a second material around a part of the ring of the first material.

13. A method according to claim 12, further comprising the step of:
bonding the second material to form a tube around the first material.
